(19) United States
(12) Patent Application Publication
(10) Pub. No.: US 2003/0000407 A1
(43) Pub. Date: Jan. 2, 2003

(54) Washing installation for printing press cylinders

(76) Inventor: Torsten Schmutz, Bobingen (DE)

Correspondence Address: OSTROLENK FABER GERB & SOFFEN, 1180 AVENUE OF THE AMERICAS, NEW YORK, NY, 100368403

(21) Appl. No.: 10/169,586

(22) PCT Filed: Jan. 5, 2001
(86) PCT No.: PCT/EP01/00064

(30) Foreign Application Priority Data
Jan. 8, 2000 (DE) 100 00 554.3

(51) Int. Cl. B41F 35/00; B41L 41/00

(52) U.S. Cl. 101/425

(57) ABSTRACT

The invention relates to a washing installation for printing press cylinders. A free-wheel drive (22) of a dirty-cloth roller (12) draws a section of a washing cloth from a clean-cloth roller (10) in each case via a pressing element (18) onto the dirty-cloth roller when a washing bar (4) that carries said components is returned from a washing position to a base position, and in the process a cloth transport lever (28) of the free-wheel drive catches on a first stop that is fastened to a holding device in which the washing bar (4) is guided. When the washing bar is inserted into the guides of the holding device, a lever arm (38) of the cloth transport lever (28) catches on a second stop that is provided on the holding device. This has the effect of moving the cloth transport lever (28) past the first stop (26) and simultaneously advancing the cloth from the clean-cloth roller (10) to the dirty-cloth roller (12).

The invention relates to a washing installation for printing press cylinders according to the preamble of claim 1.

Accordingly, the invention relates to a washing installation for printing press cylinders, containing a washing bar which can be moved transversely with respect to the printing press cylinder, in guides of a holding device between a base position, which is at a predetermined distance from the printing press cylinder to be washed, and a washing position, which is close to the printing press cylinder; mountings for a clean-cloth roller and for a dirty roller for a washing cloth, a pressing element for pressing a washing-cloth section against the peripheral surface of the printing press cylinder on its path from the clean-cloth roller over the pressing element to the dirty-cloth roller, and a free-wheel drive for driving the dirty-cloth roller being arranged on the washing bar; a first stop on the holding device by means of which a cloth transport lever of the free-wheel drive is rotated in the drive direction by the first stop preventing the cloth transport lever following the movement of the washing bar when the washing bar is returned from the washing position into the base position, while the cloth transport lever of the free-wheel drive rotates automatically in the free-wheel direction when the washing bar is moved forward from the base position into the washing position.

U.S. Pat. No. 4,344,361 discloses washing bars which have a nozzle device for spraying water onto the washing cloth on its path from the clean-cloth roller to the pressing element. On the clean-cloth roller, the washing cloth is dry. Furthermore, it is known to store a washing cloth moistened with washing agent in a moist condition on the clean-cloth roller.

In known washing installations for printing press cylinders, the washing bar is inserted from above downward between the holding devices on both sides of a machine frame and then, in an arcuate insertion movement from the top rear to the bottom front, is set into the base position. This requires a relatively large amount of space for the insertion of the washing bar into the guides of the holding device.

Before the washing bar is inserted into the guides of the holding device, a clean-cloth roll on a clean-cloth roller is inserted into the washing bar, and the start of the cloth is drawn over the pressing element to the dirty-cloth roller and fixed to the dirty-cloth roller. In the process, an attempt is made to tension the washing cloth as well as possible between the clean-cloth roller and the dirty-cloth roller, in order that the washing cloth is tensioned tautly over the pressing element during the subsequent washing operation. This tensioning of the washing cloth is frequently not performed carefully enough. In the event of a sagging washing cloth, there is the risk that it will be carried along by the printing press cylinder.

The cylinder to be cleaned in printing presses is in particular a blanket cylinder which, in the offset printing process, transfers the printing image from a plate cylinder to the printing medium or a paper web or a paper sheet. However, other cylinders of printing units in a printing press can also be washed with the washing bar.

The invention is intended to achieve the object of constructing the washing installation for printing press cylinders in such a way that less space is needed to insert the washing bar into the guides of the holding devices, the intention being at the same time to ensure that when the washing bar is inserted into the holding devices, a clean washing-cloth section automatically lies over the pressing element and the washing cloth is tensioned optimally between the clean-cloth roller and the dirty-cloth roller.

According to the invention, this object is achieved by the characterizing features of claim 1.

Accordingly, a washing installation for printing press cylinders is characterized in that the guides formed in the holding devices extend rearward in the direction of the washing position over the base position, and in that the washing bar can be moved from back to front in the guides, from an inserted position into the base position in the same direction of motion in which it can be moved forward from the base position to the washing position; in that a second lever arm is rotationally fixedly connected to the cloth transport lever for common rotational movements, at least in the drive direction of the free-wheel, in that the cloth transport lever and the second lever arm project away from each other in opposite directions, transversely with respect to the direction of the movements of the washing bar between its base position and its washing position, in that the first stop is arranged on the side of the dirty-cloth roller, on which the cloth transport lever projects, in that a second stop is arranged on the holding device on that side of the dirty-cloth roller that faces away from the one side on which the second lever arm projects; in that the second stop is arranged to be offset rearward with respect to the first stop to such an extent that the second lever arm rests on the second stop and, as a result, rotates the cloth transport lever in the drive direction to such an extent that the latter is moved past the first stop without catching when the washing bar is moved from the inserted position into the base position, the second stop forcing the second lever arm away and releasing it at the latest when the washing bar reaches the base position.

The invention has the following advantages in particular: The washing bar can be inserted from the rear into the guides of the holding devices on both sides and can be moved rectilinearly in the same direction from the insertion position into the base position, in which direction the washing bar can also be moved from the base position into a washing position and back again. Therefore, less operating space is needed for the insertion of the washing bar into the holding devices. The washing cloth is automatically tensioned as the washing bar is inserted into the holding devices, even if it could not be tensioned sufficiently tightly during manual insertion into the washing bar. When the washing bar is taken out of the holding devices after a plurality of washing operations, then, as a result of the preceding washing operation, a washing-cloth section made dirty by the cleaned cylinder is located on the pressing element. When the washing bar is inserted into the holding devices again, the washing cloth is automatically advanced, in the aforementioned way, by the lever arm catching on the second stop, so that automatically a fresh washing-cloth section comes to lie over the pressing element.

Further features of the invention are contained in the subclaims.

The invention will be described in the following text using a preferred embodiment as an example and with reference to the drawings, in which:

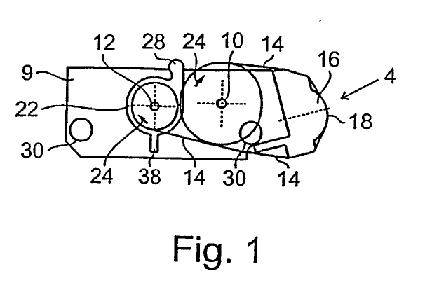

FIG. 1 shows, in schematic form, a side view of a washing bar according to the invention,

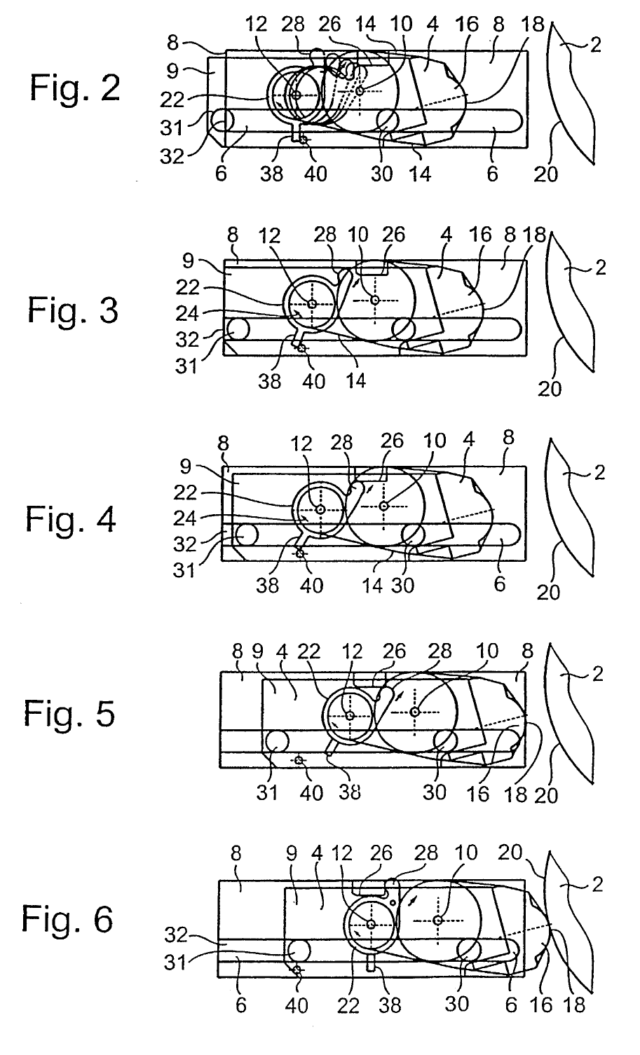

FIG. 2 shows, in schematic form, the insertion position of the washing bar in a holding device, a cloth transport lever of a free-wheel drive of a dirty-cloth roller being illustrated by continuous lines and the movement sequence of the cloth transport lever being represented by interrupted lines, said movement taking place when the washing bar is moved from the insertion position of FIG. 2 into the base position of FIG. 5,

FIG. 3 shows the washing bar in a cloth transport position during the inward movement of the washing bar from the insertion position of FIG. 2 toward the front in the direction of the base position of FIG. 5,

FIG. 4 shows in schematic form, a further cloth transport position of the washing bar during the inward movement from the insertion position of FIG. 2 toward the base position of FIG. 5,

FIG. 5 shows the base position of the washing bar, from which it can be moved out forward into a washing position for washing a cylinder,

FIG. 6 shows, in schematic form, a side view of the washing bar in the washing position for washing the cylinder,

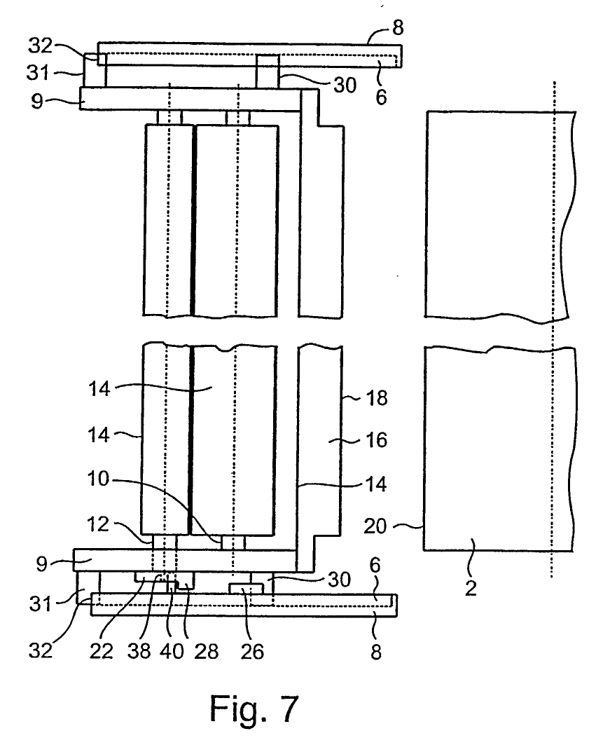

FIG. 7 shows, in schematic form, a plan view of the washing bar in the holding device in the insertion position of FIG. 2,

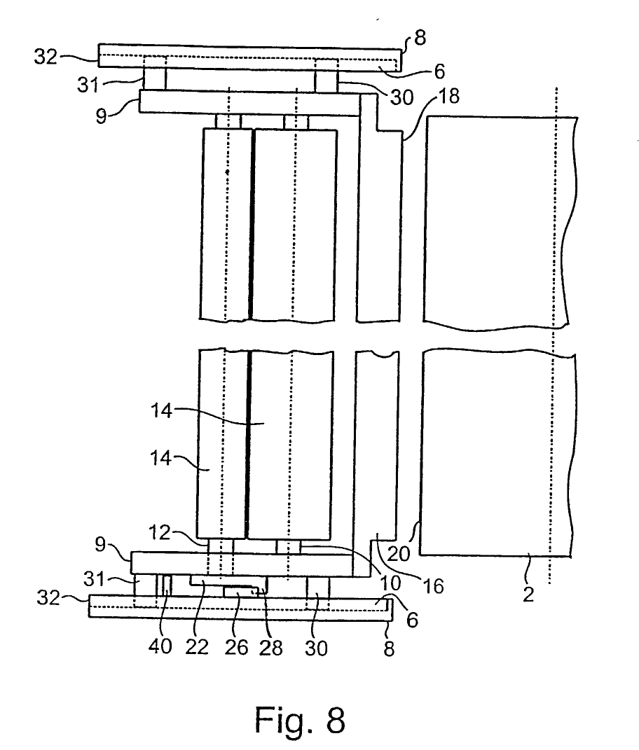

FIG. 8 shows, in schematic form, a plan view of the washing bar in the holding device in the base position of FIG. 5,

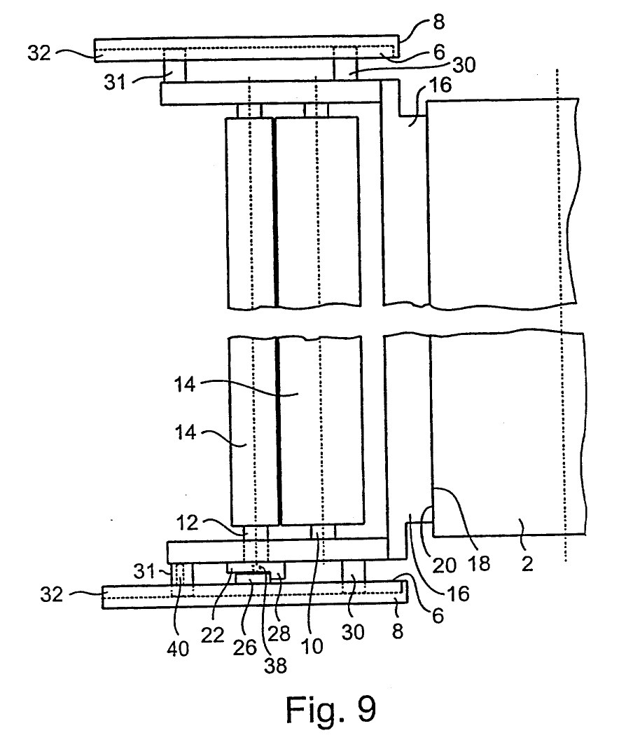

FIG. 9 shows, in schematic form, a plan view of the washing bar in the holding device in the washing position of FIG. 6,

The washing installation according to the invention for washing a cylinder 2, shown in FIGS. 1 to 9, contains a washing bar 4 which can be moved forward and backward in preferably rectilinear guide slots 6 belonging to two stationary guide plates 8 arranged parallel at a distance from each other, between the base position shown in FIG. 5, which is at a predetermined distance from the cylinder 2 to be washed, and the washing position shown in FIG. 6, which is close to the cylinder 2, at right angles to this cylinder, by a drive which is not shown but is controlled by a printing press control system, for example a hydraulic cylinder or pneumatic cylinder.

The washing bar 4 has two side plates 9 arranged parallel at a distance from each other for mounting a clean-cloth roller 10 and a dirty-cloth roller 12 for a washing cloth 14. Also provided is a pressing element 16 for pressing a washing-cloth section 18 onto the peripheral surface 20 of the cylinder 2 on the path of the washing cloth 14 from the clean-cloth roller 10 to the dirty-cloth roller 12. On the washing bar 4 there is a free-wheel drive 22 for driving the dirty-cloth roller 12, for example in the clockwise direction in accordance with arrows 24, in order to transport the washing cloth 14 step by step from the clean-cloth roller 10 over the pressing element 18 onto the dirty-cloth roller 12, such a transport step being executed each time the washing bar is moved back from the washing position of FIG. 6 into the base position of FIG. 5.

On one of the two stationary guide plates 8, which lies opposite the free-wheel drive 22 of the washing bar 4, a first stop 26 is formed, by means of which a cloth transport lever 28 of the free-wheel drive 22, together with the dirty-cloth roller 12, is rotated in the drive direction, that is to say in the clockwise direction according to the arrows 24 in the case of the embodiment illustrated, by the first stop 26 preventing the cloth transport lever 28 following the movement of the washing bar 4 when the washing bar is moved back from the washing position of FIG. 6 into the base position of FIG. 5 by the drive (not shown) under control of the control device, likewise not shown. These are not shown because they are generally known.

However, when the washing bar is moved forward from the base position of FIG. 5 into the washing position of FIG. 6, the cloth transport lever 28 is automatically rotated in the free-wheel direction, that is to say in the counterclockwise direction counter to the arrows 24 in the case of the embodiment illustrated. In this case, only the cloth transport lever 28 rotates but, because of the free-wheel action of the free-wheel drive 22, not the dirty-cloth roller 12. This back rotation of the cloth transport lever 22 in the free-wheel direction is preferably effected by a spring integrated in the free-wheel drive 22. According to another embodiment, however, a further stop could be provided on the stationary guide plates 8 for this purpose.

In the embodiment illustrated, it will be assumed that, in the washing position of FIG. 6, the pressing element 16 presses the washing-cloth section 18 located on it onto the peripheral surface 20 of the cylinder 2 in order to clean the latter while the cylinder 2 rotates and the washing cloth 14 is stationary. According to another embodiment, however, the washing-cloth section 18 in the washing position of FIG. 6 could still be at a small distance from the peripheral surface 20 of the cylinder and could be pressed onto the cylinder 2 by means of an additional movement of the pressing element 16 relative to the side plates 9 of the washing bar 4. Such embodiments are known from the prior art and have an inflatable rubber lip, for example, as the pressing element 16.

Each of the two side plates 9 of the washing bar 4 bears, with a longitudinal spacing, two roller pins 30 and 31 (rollers mounted on pins) which are arranged one behind the other and project laterally outward and which, on both sides of the washing bar 4, each engage in one of the guide slots 6 of the stationary guide plates 8. At their rear end 32, the slots 6 are open. As a result, the washing bar 4 can be inserted from the rear with its roller pins 30 and 31 into the rear slot ends 32, in the slot longitudinal direction, and as a result can be brought into the insertion position of FIG. 2. At their front end, facing the cylinder 2, the slots 6 can be open or closed.

In FIGS. 2 to 6, the washing bar 4 and the stationary guide plates 8 with the guide slots 6 are drawn one above another in side view, in order better to be able to see the movement sequences of the washing bar 4 and its parts. The lateral arrangement of the washing bar 4 between the stationary guide plates 8 can be seen from FIGS. 7, 8 and 9. The guide slots 6 extend rearward in the guide plates 8 in the direction of the front washing position of FIG. 6 until they are beyond the base position of FIG. 5, so that the washing bar 4 can be inserted into the guide slots 6 from the rear toward the front in their open, rear slot end 32 in the same direction of movement as it can be moved forward from the base position of FIG. 5 into the washing position of FIG. 6, and can be introduced into the guide slots 6, in which both the front and the rear roller pins 30 and 31 are in the guide slots 6 and hold the washing bar 4 such that it cannot tilt.

A second lever arm 38 is rotationally fixedly connected to the cloth transport lever 28 for common rotational movements, at least in the drive direction 24. The second lever arm 38 and the cloth transport lever 28 can be two parts or can preferably together consist of a single-piece material part.

The cloth transport lever 28 and the second lever arm 38 project away from each other in opposite directions, transversely to the direction of the movements of the washing bar 4 between its base position of FIG. 5 and its washing position of FIG. 6, the cloth transport lever 28 projecting upward and the second lever arm 38 projecting downward in the embodiment illustrated.

The first stop 26 is arranged on the side (upper side) of the dirty-cloth roller 12 on which the cloth transport lever 28 projects.

A second stop 40 is located on the guide plate 8 which is adjacent to the free-wheel drive 22, on that side (lower side) of the dirty-cloth roller 12 which faces away from the one side (upper side) on which the second lever arm 38 projects. Both stops 26 and 40 are arranged on the same guide plate 8 and both project forward and inward from the latter in the direction of the washing bar 4.

The second stop 40 is arranged to be offset so far rearward with respect to the first stop 26 that the second lever arm 38 rests on the second stop 40 and, as a result, rotates the cloth transport lever 28 in the drive direction 24 to such an extent that said lever is moved past the first stop 26 without catching when the washing bar 4 is moved forward from the insertion position of FIG. 2 into the base position of FIG. 5 in the guide slots 6. During these movements, the second stop 40 holds the second lever arm 38 firmly, the second lever arm 38 running over the second stop 40 and being released by this second stop 40 at the latest when the washing bar 4 reaches the base position of FIG. 5.

According to the preferred embodiment, the dimensions are chosen in such a way that the second lever arm 38 and therefore also the cloth transport lever 28 are rotated through a rotational angle in the drive direction 24 while, during the inward movement of the washing bar 4 from the insertion position of FIG. 2 into the base position of FIG. 5, it remains caught on the second stop 40, which corresponds to a predetermined transport distance of the washing cloth 14 around the pressing element 16, by which transport distance the washing cloth is transported by the cloth transport lever 28 when the washing bar 4 is moved back from the washing position of FIG. 6 into the base position of FIG. 5, even with an extremely small diameter of the dirty-cloth coil on the dirty-cloth roller 12.

If the rotational angle of the cloth transport lever 28 in the drive direction 24 is of the same size each time the washing bar 4 is moved back from the washing position of FIG. 6 into the base position of FIG. 5, then the advance distance of the washing cloth 14 produced in the process is greater, the greater the coil diameter of the washing cloth 14 on the dirty-cloth roller 12 becomes. In order that this is not the case, but an equally large washing cloth distance of the washing cloth 4 is transported onward around the pressing element 16 during each return stroke of the washing bar 4 from the washing position of FIG. 6 into the base position of FIG. 5, known measures are provided, which are therefore not described in detail here, in order to produce constant advance distances of the washing cloth 14 with a changing coil diameter of the washing cloth on the dirty-cloth roller 12.

The washing cloth 14 can already be pre-moistened on the clean-cloth roller 10, as in the prior art, or spray nozzles or other liquid feed means can be provided in order to moisten the washing cloth 14 on its movement path from the clean-cloth roller 10 to the pressing element 16, as is known from the prior art.

1. A washing installation for printing press cylinders, containing a washing bar (4) which can be moved transversely with respect to the printing press cylinder, in guides (6) of a holding device (8) between a base position (FIG. 5), which is at a predetermined distance from the printing press cylinder to be washed, and a washing position (FIG. 6), which is close to the printing press cylinder; mountings for a clean-cloth roller (10) and for a dirty roller (12) for a washing cloth (14), a pressing element (16) for pressing a washing-cloth section (18) against the peripheral surface of the printing press cylinder on its path from the clean-cloth roller over the pressing element to the dirty-cloth roller, and a free-wheel drive (22) for driving the dirty-cloth roller (12) being arranged on the washing bar; a first stop (26) on the holding device (8) by means of which a cloth transport lever (28) of the free-wheel drive (22) is rotated in the drive direction by the first stop preventing the cloth transport lever (28) following the movement of the washing bar (4) when the washing bar (4) is returned from the washing position (FIG. 6) into the base position (FIG. 5), while the cloth transport lever (28) of the free-wheel drive (22) rotates automatically in the free-wheel direction when the washing bar is moved forward from the base position into the washing position;
characterized in that
the guides (6) formed in the holding devices (8) extend rearward in the direction of the washing position (FIG. 6) over the base position (FIG. 5), and in that the washing bar (4) can be moved from back to front in the guides, from an inserted position (FIG. 2) into the base position (FIG. 5) in the same direction of motion in which it can be moved forward from the base position to the washing position; in that a second lever arm (38) is rotationally fixedly connected to the cloth transport lever for common rotational movements, at least in the drive direction of the free-wheel, in that the cloth transport lever and the second lever arm project away from each other in opposite directions, transversely with respect to the direction of the movements of the washing bar between its base position and its washing position, in that the first stop (26) is arranged on the side of the dirty-cloth roller, on which the cloth transport lever (28) projects, in that a second stop (40) is arranged on the holding device (8) on that side of the dirty-cloth roller (12) that faces away from the one side on which the second lever arm (38) projects; in that the second stop (40) is arranged to be offset rearward with respect to the first stop (26) to such an extent that the second lever arm (38) rests on the second stop (40) and, as a result, rotates the cloth transport lever (28) in the drive direction to such an extent that the latter is moved past the first stop (26) without catching when the washing bar is moved from the inserted position into the base position, the second stop (40) forcing the second lever arm (38) away and releasing it at the latest when the washing bar reaches the base position.

2. The washing installation for printing press cylinders as claimed in claim 1, characterized in that the guides (6) are rectilinear.

3. The washing installation for printing press cylinders as claimed in claim 1 or 2, characterized in that the cloth transport lever (28) and the second lever arm (38) are together a one-piece material part.
